(19) United States
(12) Patent Application Publication
(10) Pub. No.: US 2018/0018445 A1
(43) Pub. Date: Jan. 18, 2018

(54) Social Sharing of Software Products

(71) Applicant: International Business Machines Corporation, Armonk, NY (US)

(72) Inventors: Shang Q. Guo, Cortlandt Manor, NY (US); Jonathan Lenchner, North Salem, NY (US); Maharaj Mukherjee, Poughkeepsie, NY (US); Jan S. Pluim, Raleigh, NC (US)

(21) Appl. No.: 15/209,122

(22) Filed: Jul. 13, 2016

(51) Int. Cl. G06F 21/12; G06Q 40/00

(52) U.S. Cl. CPC G06F 21/12; G06Q 40/12

(57) ABSTRACT

Methods, systems, and computer program products for sharing of software products are provided herein. A computer-implemented method includes selecting a hardware device within a network of hardware devices, each containing a particular licensed software product, in response to a user request for usage of the particular licensed software product. The method also includes transmitting a request to the selected hardware device that comprises a request to permit the user usage of the particular licensed software product via the selected hardware device, and establishing a communication link between a hardware device of the user and the selected hardware device upon receiving an acceptance of the request. Additionally, the method includes implementing, based on the usage of the particular licensed software product by the user during the communication link, a payment mechanism among the user, an entity associated with the selected hardware device, and a licensor of the particular licensed software product.

### FIELD

The present application generally relates to information technology, and, more particularly, to multi-party software sharing techniques.

### BACKGROUND

Existing approaches for delivering software products to customers include software licensing and software as a service (SaaS). With software licensing, a user is licensed to use a software product by paying an up-front licensing fee. The user accesses the software by downloading it from media such as a compact disk or from the internet, at which point the user can run the software on his or her personal machine(s). However, if the user wishes to obtain newer versions of the software, the user commonly is required to pay a new licensing fee for the newer version. Additionally, if the license is attached to a particular hardware device, and if the user buys a different hardware device subsequent to purchasing the license, the user commonly is required to pay the licensing fee again for use of the software on the new hardware device.

Accordingly, the licensing costs associated with existing software licensing approaches are often high. Further, such high licensing costs can lead to the creation of unauthorized secondary markets for such products, which can limit the licensing revenue of the developer of the software product.

With SaaS approaches, users obtain the right to use a software product via a subscription model. By paying a recurring subscription fee, the user can run the software product on the hardware of the seller itself. In this case, the user does not have to pay an up-front licensing fee or pay for newer versions or patches and bug fixes. However, the company selling the software incurs costs in creating, owning and/or leasing a hardware infrastructure for running all of the software access requests, and such costs associated with owning, leasing and/or maintaining the hardware infrastructure can be significant. Further, such costs are often factored-in to the subscription cost of the user, rendering the use of the software product expensive.

### SUMMARY

In one embodiment of the present invention, techniques for social sharing of software products are provided. An exemplary computer-implemented method can include selecting a hardware device within a network of multiple hardware devices, each containing a particular licensed software product, in response to a user request for usage of the particular licensed software product. Such a method can also include transmitting a request to the selected hardware device, wherein the request comprises a request to permit the user usage of the particular licensed software product via the selected hardware device, and establishing a communication link between a hardware device of the user and the selected hardware device upon receiving an acceptance of the request from the selected hardware device. Further, such a method can include implementing, based on the usage of the particular licensed software product by the user on the selected hardware device during the established communication link, a payment mechanism among (i) the user, (ii) an entity associated with the selected hardware device, and (iii) a licensor of the particular licensed software product.

Another embodiment of the invention or elements thereof can be implemented in the form of an article of manufacture tangibly embodying computer readable instructions which, when implemented, cause a computer to carry out a plurality of method steps, as described herein. Furthermore, another embodiment of the invention or elements thereof can be implemented in the form of an apparatus including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a flow diagram illustrating techniques according to an embodiment of the invention; and

FIG. 3 is a system diagram of an exemplary computer system on which at least one embodiment of the invention can be implemented.

### DETAILED DESCRIPTION

As described herein, an embodiment of the present invention includes techniques for social sharing of software products. At least one embodiment of the invention includes sharing software products over an ad hoc computer network via three parties, wherein a first party provides the software license, a second party provides runtime access to the software product, and a third party is the purchasing party.

Based on a request to use a particular software product, an example embodiment of the invention can include identifying an appropriate computing system (hardware device) that contains the requested software within a given network, and requesting permission for the running of the software on the identified computing system. Upon such permission being granted, one or more embodiments of the invention can additionally include running the requested software product on the identified computing system, and determining the identity of the party providing the runtime access. Such a determination can be carried out, for example, at purchase time, wherein the identity can vary from purchase to purchase. In one or more embodiments of the invention, a purchase time can be defined as the time when a contract is made and the software begins executing. The purchase duration can be a predefined time from the purchase time or until the requester makes a request to stop the execution of the software.

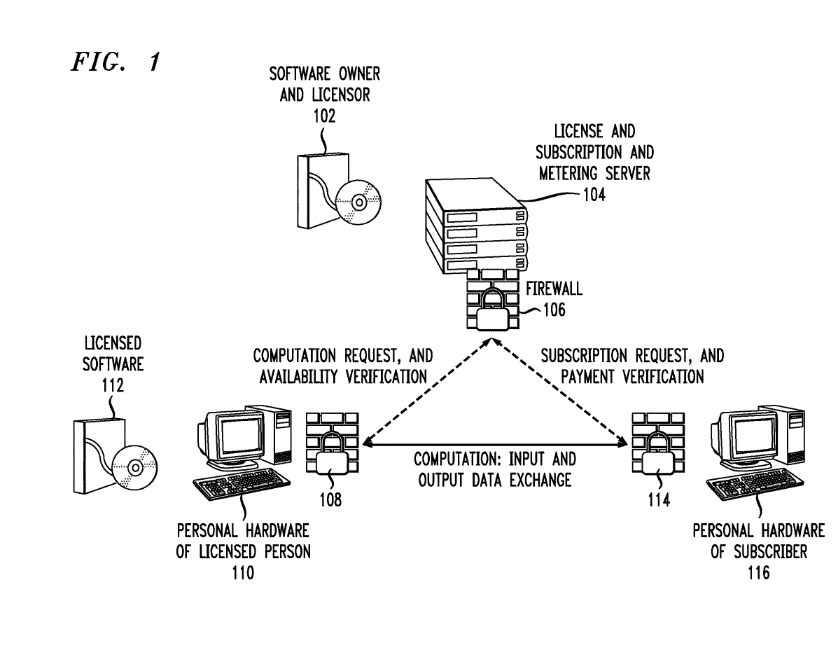

Accordingly, as further detailed herein, one or more embodiments of the invention include techniques for sharing software licenses through an ad hoc virtual cloud in a tripartite exchange of software, hardware and payment (money, etc.). FIG. 1 is a diagram illustrating system architecture, according to an embodiment of the invention. By way of illustration, FIG. 1 depicts a tripartite model amongst a software owner and licensor 102, a software licensee (with personal hardware 110), and a software subscriber (with personal hardware 116 and a firewall 114). A licensed software product 112 contained within a user's personal computer (PC) or any other computing device 110 (with a firewall 108) such as a personal digital assistant (PDA), a tablet, a smart phone, etc., can be made available to other users who do not have a license.

Additionally, each firewall (106, 108, and 114) depicted in FIG. 1 provides a protection of privacy and security to its respective owner by thwarting intrusion using a mechanism of encryption and/or other security means. During an example transaction, the firewall of each party in the tripartite transaction can also perform additional functions. For example, firewall 106 provides protection of the licensing and metering mechanism, such that the interest of the software licensor is protected. Firewall 108 provides protection to hardware as well as additional software and applications residing on the hardware of the entity providing the software and hardware support. Firewall 114 provides protection to hardware as well as additional software and applications residing on the hardware of the subscribing and requesting entity requesting the software and hardware support.

In at least one embodiment of the invention, the entire exchange can be carried out either by the user, the original product seller/developer of the software, or a third party (for example, the entity providing the software and hardware support). The occasional users can pay for usage of the software on a pay-as-you-go basis, a per-usage basis, or a subscription basis. The payment can be transferred and/or shared among the original product seller/developer, the license holder, and the third party who is facilitating this service. Such a mechanism can include, for example, a lowered license fee or any other means of payment.

Referring again to FIG. 1, an example embodiment of the invention can include implementing an algorithm that includes initial conditions of a list of subscribers S₁, . . . , Sₙ, and a list of licensed software holders L₁, . . . Lₙ. Via the algorithm, a subscriber Sⱼ (via hardware device 116, for example) makes a request to a license and subscription server 104 (with a firewall 106) to use the software (SW). The license server 104 determines the most appropriate hardware Lⱼ (such as 110, for example) to run the request of Sᵢ for the SW based on availability of various hardware devices, current work load of various hardware devices, as well as the network speed associated with various hardware devices.

When Lⱼ confirms that it can run the request of Sᵢ, a communication link is set-up between Sᵢ and Lⱼ. Subsequently, Sᵢ uses the SW on the hardware device of Lⱼ using Sᵢ's input, and Sᵢ receives the output. The inputs can include, for example, user selections and customizations for a software prior to the execution, as well as additional data and input selection during the execution of the software. The output can include, for example, user options as well as results of the software during and at the end of the execution based on the user selection and input data.

Additionally, the license server 104 meters the SW usage of Sᵢ on Lⱼ. When Sᵢ has finished usage of the SW on Lⱼ, the communication link is closed, Sᵢ is billed for the metered usage, and Lⱼ is paid according to the metered usage. In one or more embodiments of the invention, the software licensor serves as the central clearing house for payment. The requester makes the payment to the licensor based on the metering, and the licensor shares the revenue with the entity providing the software and hardware support, either in terms of cash or credit for owning and using the licensed software.

At least one embodiment of the invention can be implemented via an application (app), by means of which a user decides whether he or she wants to use a given software product on his or her hardware by downloading the software, or whether he or she would like to use the software product on a subscription basis on a different hardware device. When the user decides that he or she would like to download the software on his or her own hardware device, the user is provided with an option (through the app) of whether he or she would allow others to run the software on his or her hardware device. Once the user agrees to the licensing and payment options, the user's name is placed into pools of licensed users and subscribed users, respectively.

When a subscribed user makes a request to use the software, the system (implemented via the app, for example) determines and/or identifies the most suitable hardware device within the network of users upon which the software can be used. Such a determination can be based, for example, on the availability of each hardware device in the network, the size of the project to be carried out via the software, as well as traffic within the network. Once the determination is made, the subscribed user is connected over the computer network to the identified licensed user's hardware device. The licensed user need not be aware of the identity of the subscribed user using his or her hardware device. At the end of the use, the respective accounts of the subscribed user and the licensed user are updated in connection with the proper payment associated with the software usage. In one or more embodiments of the invention, the proper payment can be agreed upon by all parties prior to the transaction, and similarly verified at the end of the transaction by all parties as well.

In at least one embodiment of the invention, the subscriber's request can be made through a browser or through the app. The licensed user (who allows the use of the licensed product via his or her hardware device) can be compensated by metering the usage time of the software and/or by metering the number of times his or her device is used by a subscribed user. Additionally, the subscribed user can pay for his or her use of the software via a metered model that uses the length of the use and/or the frequency of use for both the software and hardware platform. Alternatively, the subscribed user can pay a regular subscription fee via a subscribed model.

Also, in one or more embodiments of the invention, a subscribed user can utilize a virtual platform created by an ad hoc network of multiple connected devices. In such an embodiment, the proposed job of the subscribed user is divided into multiple subtasks, and each subtask is executed on a separate device on the ad hoc network. In such a scenario, each of the noted devices contains the licensed software product sought by the subscribed user to carry out the job in question. Also, the owner of each such device can be compensated using models such as detailed above.

Additionally, in one or more embodiments of the invention, the subscriber can include an internet-connected cognitive device in an intelligent internet of things (IoT) network. In such an embodiment, the payment can be made by the owner of the IoT network. Further, in at least one embodiment of the invention, some of the subscribers can be treated as preferred customers and offered increased network speeds as well as faster hardware machines, as available, in exchange for higher payments.

By way of additional example, consider implementation of an embodiment of the invention via a home network. In such a scenario, an example embodiment of the invention includes enabling a user to obtain a license for a software product in only one or two of the computers within the home network, and still use the licensed software in other computers using a subscription model that will share the software with additional computers within the network. Similarly, in a business or enterprise network, a company may choose to download the licensed software on a limited number of computers, and subsequently use the subscription model for usage of the software on additional computers.

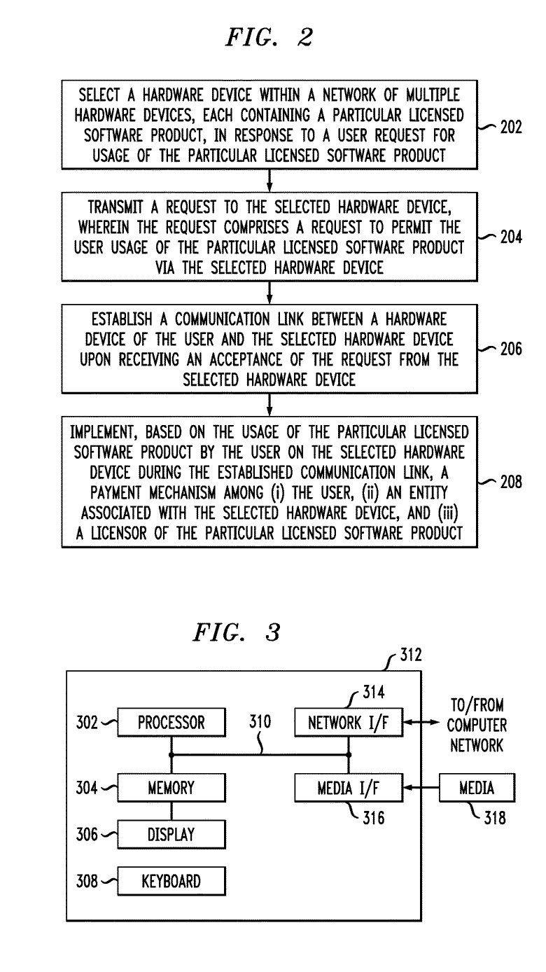

FIG. 2 is a flow diagram illustrating techniques according to an embodiment of the present invention. Step 202 includes selecting a hardware device within a network of multiple hardware devices, each containing a particular licensed software product, in response to a user request for usage of the particular licensed software product. The network can include an ad hoc network of multiple hardware devices, each containing the particular licensed software product. Additionally, selecting can be based on availability of each of the multiple hardware devices within the network, the current work load of each of the multiple hardware devices within the network, the size of the requested usage of the particular licensed software product, and/or traffic within the network.

Additionally, at least one embodiment of the invention can include dividing the user-requested usage of the particular licensed software product into multiple subtasks. Such an embodiment can also include selecting a distinct hardware device within the network for each of the multiple subtasks.

Step 204 includes transmitting a request to the selected hardware device, wherein the request comprises a request to permit the user usage of the particular licensed software product via the selected hardware device. In at least one embodiment of the invention, the user can include an internet-connected cognitive device in an intelligent internet of things network.

Step 206 includes establishing a communication link between a hardware device of the user and the selected hardware device upon receiving an acceptance of the request from the selected hardware device.

Step 208 includes implementing, based on the usage of the particular licensed software product by the user on the selected hardware device during the established communication link, a payment mechanism among (i) the user, (ii) an entity associated with the selected hardware device, and (iii) a licensor of the particular licensed software product. The usage of the particular licensed software product via the selected hardware device by the user can include utilization of input specific to the user to obtain an output specific to the user.

The techniques depicted in FIG. 2 can also include metering the usage of the particular licensed software product by the user on the selected hardware device during the established communication link. Metering can include metering the amount of time of the usage and/or metering the number of distinct instances of usage of the particular licensed software product by the user on the selected hardware device.

Further, the techniques depicted in FIG. 2 can additionally include terminating the communication link between the hardware device of the user and the selected hardware device upon receipt of an indication that the usage of the particular licensed software product by the user on the selected hardware device is completed. The indication can include expiry of a predetermined temporal limit and/or a notification actively transmitted by the user.

At least one embodiment of the invention (such as the techniques depicted in FIG. 2, for example), can include implementing a service via a transmission server to receive data from a data source and send selected data to users (for example, at a provided destination address of a wireless device (such as a number for a cellular phone, etc.)). The transmission server includes a memory, a transmitter, and a microprocessor. Such an embodiment of the invention can also include providing a viewer application to the users for installation on their individual devices. Additionally, in such an embodiment of the invention, after a user enrolls, the service receives a request to access a particular licensed software product, sent from a data source to the transmission server. The server can process the information, for example, based upon user-provided user preference information and/or network policies that can be stored in memory on the server. Subsequently, an alert is generated containing an acknowledgment of an established communication link permitting the user access to the licensed software on a selected hardware device within the network. The alert can be formatted into data blocks, for example, based upon any provided alert format preference information. Subsequently, the alert and/or formatted data blocks are transmitted over a data channel to the user's wireless device. After receiving the alert, the user can connect the wireless device to the user's computer, whereby the alert causes the user's computer to automatically launch the application provided by the service to display the alert. When connected to the Internet, the user may then use the viewer application (for example, via clicking on a URL associated with the data source provided in the alert) to facilitate a connection from the remote user computer to the data source over the Internet for additional information.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Additionally, an embodiment of the present invention can make use of software running on a computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, sharing software licenses through an ad hoc virtual cloud in a tripartite exchange of software, hardware and payment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
selecting a hardware device within a network of multiple hardware devices, each containing a particular licensed software product, in response to a user request for usage of the particular licensed software product;
transmitting a request to the selected hardware device, wherein the request comprises a request to permit the user usage of the particular licensed software product via the selected hardware device;
establishing a communication link between a hardware device of the user and the selected hardware device upon receiving an acceptance of the request from the selected hardware device; and
implementing, based on the usage of the particular licensed software product by the user on the selected hardware device during the established communication link, a payment mechanism among (i) the user, (ii) an entity associated with the selected hardware device, and (iii) a licensor of the particular licensed software product;
wherein the steps are carried out by at least one computing device.

2. The computer-implemented method of claim 1, wherein the network comprises an ad hoc network of multiple hardware devices, each containing the particular licensed software product.

3. The computer-implemented method of claim 1, wherein said selecting is based on availability of each of the multiple hardware devices within the network.

4. The computer-implemented method of claim 1, wherein said selecting is based on the current work load of each of the multiple hardware devices within the network.

5. The computer-implemented method of claim 1, wherein said selecting is based on the size of the requested usage of the particular licensed software product.

6. The computer-implemented method of claim 1, wherein said selecting is based on traffic within the network.

7. The computer-implemented method of claim 1, wherein the user comprises an internet-connected cognitive device in an intelligent internet of things network.

8. The computer-implemented method of claim 1, wherein the usage of the particular licensed software product via the selected hardware device by the user comprises utilization of input specific to the user to obtain an output specific to the user.

9. The computer-implemented method of claim 1, comprising:
metering the usage of the particular licensed software product by the user on the selected hardware device during the established communication link.

10. The computer-implemented method of claim 9, wherein said metering comprises metering the amount of time of the usage.

11. The computer-implemented method of claim 9, wherein said metering comprises metering the number of distinct instances of usage of the particular licensed software product by the user on the selected hardware device.

12. The computer-implemented method of claim 1, comprising:
terminating the communication link between the hardware device of the user and the selected hardware device upon receipt of an indication that the usage of the particular licensed software product by the user on the selected hardware device is completed.

13. The computer-implemented method of claim 12, wherein the indication comprises expiry of a predetermined temporal limit.

14. The computer-implemented method of claim 12, wherein the indication comprises a notification actively transmitted by the user.

15. The computer-implemented method of claim 1, comprising:
dividing the user-requested usage of the particular licensed software product into multiple subtasks.

16. The computer-implemented method of claim 15, comprising:
selecting a distinct hardware device within the network for each of the multiple subtasks.

17. A computer program product comprising a computer readable storage medium having program instructions embodied therewith, the program instructions executable by a device to cause the device to:
select a hardware device within a network of multiple hardware devices, each containing a particular licensed software product, in response to a user request for usage of the particular licensed software product;
transmit a request to the selected hardware device, wherein the request comprises a request to permit the user usage of the particular licensed software product via the selected hardware device;
establish a communication link between a hardware device of the user and the selected hardware device upon receiving an acceptance of the request from the selected hardware device; and
implement, based on the usage of the particular licensed software product by the user on the selected hardware device during the established communication link, a payment mechanism among (i) the user, (ii) an entity associated with the selected hardware device, and (iii) a licensor of the particular licensed software product.

18. The computer program product of claim 17, wherein the program instructions executable by a computing device further cause the computing device to:
meter the usage of the particular licensed software product by the user on the selected hardware device during the established communication link.

19. A system comprising:
a memory; and
at least one processor coupled to the memory and configured for:
selecting a hardware device within a network of multiple hardware devices, each containing a particular licensed software product, in response to a user request for usage of the particular licensed software product;
transmitting a request to the selected hardware device, wherein the request comprises a request to permit the user usage of the particular licensed software product via the selected hardware device;
establishing a communication link between a hardware device of the user and the selected hardware device upon receiving an acceptance of the request from the selected hardware device; and
implementing, based on the usage of the particular licensed software product by the user on the selected hardware device during the established communication link, a payment mechanism among (i) the user, (ii) an entity associated with the selected hardware device, and (iii) a licensor of the particular licensed software product.

20. The system of claim 19, wherein the at least one processor is further configured for:
metering the usage of the particular licensed software product by the user on the selected hardware device during the established communication link.
